(19) United States
(12) Patent Application Publication
(10) Pub. No.: US 2022/0135396 A1
(43) Pub. Date: May 5, 2022

(54) ORTHOTIC RIDING STIRRUP AND BOOT INTERFACE

(71) Applicants: Jennifer Reale Criscione, Wellington, FL (US); David Paul Jolliff, Wellington, FL (US)

(72) Inventors: Jennifer Reale Criscione, Wellington, FL (US); David Paul Jolliff, Wellington, FL (US)

(21) Appl. No.: 17/445,979

(22) Filed: Aug. 26, 2021

Related U.S. Application Data
(60) Provisional application No. 63/106,956, filed on Oct. 29, 2020.
(60) Provisional application No. 63/058,267, filed on Jul. 29, 2020.

(51) Int. Cl. B68C 3/00; A43B 5/00

(52) U.S. Cl. CPC B68C 3/00; A43B 5/006

(57) ABSTRACT

An orthotic stirrup interface between a horse and a rider is disclosed. Aspects of the invention include an improved stirrup, an orthotic riding boot, and an indexed interface between the stirrup and orthotic riding boot. Embodiments of the present invention provide for a positive indexed engagement between the foot of a rider and the stirrups. The positive indexed engagement provides greater stability and control of the rider with the horse, improves safety of the rider and horse. An orthotic profile to the stirrup reduces pain and discomfort in the rider's feet. Embodiments for each of a thoroughbred racing stirrup and a therapy riding stirrup and associated footwear are disclosed.

### CROSS-REFERENCE TO RELATED APPLICATION

This application claims the benefit of priority of U.S. provisional application No. 63/058,267 filed Jul. 29, 2020, and U.S. provisional application No. 63/106,956, filed Oct. 29, 2020, the contents of which are herein incorporated by reference.

### BACKGROUND OF THE INVENTION

The present invention relates to riding stirrups, and more particularly to riding stirrups for equine saddles.

Since the first stirrups were made, stirrups served the purpose of aiding the rider in mounting the horse and to support the rider's feet and body while riding. The shape of the stirrups have remained consistent, featuring a flat bottom base and a teardrop inverted U-shaped curvature that spans from the left to the right side of the foot, when received within the stirrup.

A first issue with conventional stirrups is support. Conventional stirrups offer no anatomical or orthotic support. This can lead to pain during and after riding due to improper foot positioning.

A second issue with conventional stirrups is safety. Conventional stirrups can lead to the rider getting caught in their stirrup if their foot slides too far forward in the stirrup. Riders can also slip or lose footing easily due to a lack of a grip or frictional interface with the stirrup base.

A third issue with conventional stirrups is positioning, particularly in thoroughbred horse racing. As the inventors have observed upon careful review of a jockey's foot positioning, almost all jockeys will turn the stirrups completely flush against the horse. This goes against the original design and intention for conventional stirrups.

In the context of hippotherapy and therapy riding, traditional stirrups do not provide proper anatomical support, or any type of arch support allowing proper alignment or support for the rider. Disabled, injured, or rehabilitating riders are not able to fully recognize when the foot is in the stirrup itself, and often lose feeling or sensation in their legs or feet due to the lack of connection in a traditional stirrup. Traditional stirrups were never intended for rehabilitation or therapy use.

As can be seen, in almost all riding contexts, conventional riding stirrups do not take the rider's anatomy into account, leaving the primary interface between rider and horse unchanged over the millennia since the advent of the stirrup. They also provide no orthotic support, leaving riders with pain or ailments after long term use of conventional stirrups. This can lead to issues with the feet, ankles, legs, and joints.

As can be seen, there is a need for improved stirrup providing an orthotic interface between the horse and the rider.

### SUMMARY OF THE INVENTION

In one aspect of the present invention, a riding stirrup is disclosed. The riding stirrup includes an inverted U-shaped arch having a downwardly extending aft bar and a downwardly extending forward bar. A baseplate extends between the downwardly extending aft bar and the downwardly extending forward bar. The baseplate has an ovoid teardrop shape with a wide portion positioned forwardly, proximal to the downwardly extending forward bar and converges inwardly towards the downwardly extending aft bar. An instep portion of the baseplate is defined by an elevated region to support a medial longitudinal arch of a rider's foot and a transverse arch of the rider's foot, when received in the riding stirrup.

In some embodiments, strap opening is substantially aligned with a longitudinal axis of the riding stirrup along an arch of the downwardly extending forward bar and the downwardly extending aft bar, such that, when coupled with a saddle, the longitudinal axis of the riding stirrup is configured to be substantially aligned with a longitudinal length of a horse.

In some embodiments, an elevated transverse arc is defined at forward end of the baseplate between a medial aspect of the baseplate and a lateral aspect of the baseplate and aft of the downwardly extending forward bar. The elevated transverse arc angles rearwardly from the medial aspect to the lateral aspect of the baseplate. The elevated transverse arc is configured to align with a space between a head of a metatarsal of the rider's foot and toes of the rider's foot.

In some embodiments, the elevated transverse arc is configured for an indexed engagement with a corresponding transverse arc defined in a bottom sole of a footwear worn by a rider. The elevated transverse arc may have a radius of curvature of between about 50 degrees and 60 degrees. Preferably, the elevated transverse arc has a radius of curvature of about 55 degrees.

In some embodiments, a toe notch is defined at the forward end of the baseplate and is interposed between the elevated transverse arc and the downwardly extending forward bar.

In some embodiments, a medial face of the toe notch is dimensioned to carry a first through a third toe of a rider in a gripping relation at a forward end of the baseplate.

In some embodiments, a lateral face of the toe notch is dimensioned carry a fourth and a fifth toe of a rider in a griping relation with the forward end of the baseplate.

In some embodiments, the baseplate has a lateral width at a mid portion that is dimensioned to provide an orthotic support to the medial longitudinal arch and a lateral longitudinal arch of the rider's foot. The mid portion may have a depression with a radius of curvature of between about 39 degrees and 49 degrees. Preferably, the depression is about 44 degrees.

In yet other embodiments, an elastomeric pad may be applied to the baseplate to provide a cushion between the baseplate and a footwear of the rider.

In other aspects of the invention, a therapy riding stirrup is disclosed, the therapy riding stirrup includes a generally inverted U-shaped frame having a base leg interconnecting a pair of downwardly extending legs. A strap slot is defined at an apex of the inverted U-shaped frame for retaining the therapy riding stirrup with a saddle. An ellipsoidal bottom pad is coupled with the base leg and is configured to be indexed with a corresponding ellipsoidal region defined on a bottom sole of a therapy riding boot to allow a rider to have an indexed engagement of the therapy riding boot with the therapy riding stirrup.

In some embodiments, ellipsoidal lateral pads are coupled with the pair of downwardly extending legs.

In some embodiments, an attachment aperture is defined on the pair of downwardly extending legs, at roughly a 10:00 and a 2:00 position.

In some embodiments, an attachment tab is provided on an outer side of the ellipsoidal lateral pads. The attachment tab is configured for resilient engagement with the attachment apertures.

In some embodiments, the ellipsoidal lateral pads are oriented downwardly and inwardly to impart a slight pressure on a rider's foot to provide for a more positive engagement with the rider's foot in the therapy riding stirrup.

In other embodiments, a low-friction material covering an outer surface of the ellipsoidal lateral pads.

These and other features, aspects and advantages of the present invention will become better understood with reference to the following drawings, description and claims.

### BRIEF DESCRIPTION OF THE DRAWINGS

FIG. 1 is a perspective view of the orthotic riding stirrup and boot interface, shown in-use.

FIG. 2 is a perspective view of the orthotic riding stirrup.

FIG. 3 is a top view of the orthotic riding stirrup, shown with a foot alignment.

FIG. 4 is a side view of the orthotic riding stirrup.

FIG. 5 is a section view taken along line 5-5 from FIG. 3

FIG. 6 is a section view taken along line 6-6 from FIG. 3, shown with strap 38.

FIG. 7 is a perspective view of an orthotic riding boot.

FIG. 8 is a top plan view of the orthotic riding boot.

FIG. 9 is a bottom plan view of the orthotic riding boot.

FIG. 10 is the inside view of the orthotic riding boot.

FIG. 11 is a perspective view of an orthotic therapy stirrup.

FIG. 12 is an exploded view of the orthotic therapy stirrup.

### DETAILED DESCRIPTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, embodiments of the present invention provide an orthotic interface between a horse and a rider. Aspects of the invention include an improved stirrup, an orthotic riding boot, and an indexed interface between the stirrup and orthotic riding boot.

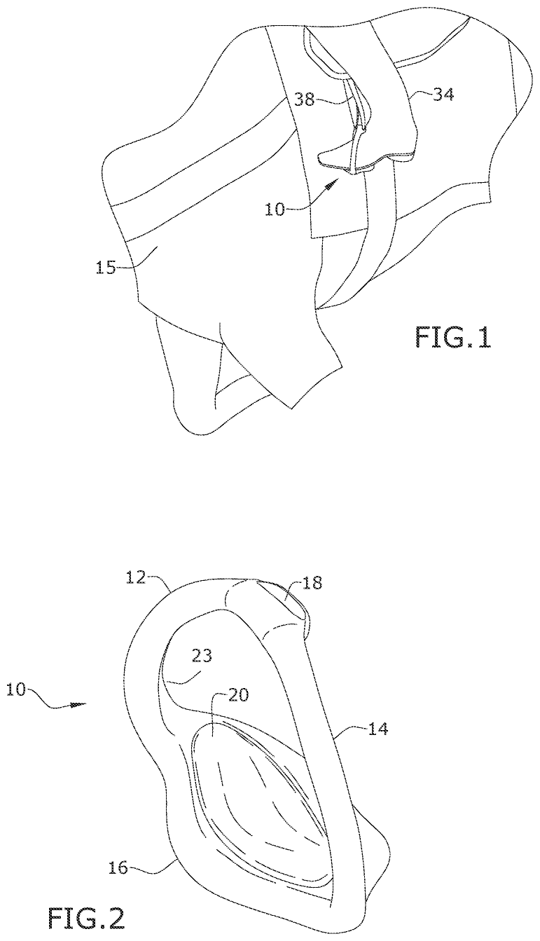

As seen in reference to the drawings of FIG. 1, a rider 34 is shown mounted on a horse 15. Stirrups 10 are coupled with a saddle 35 via a strap 38. The rider 34 inserts the toes of their foot into the stirrups 10 providing the primary interface between the rider 34 and the horse 15. Embodiments of the present invention provide for a positive indexed engagement between the foot of a rider 34 and the stirrups 10. The positive indexed engagement provides greater stability and control of the rider 34 with the horse, improves safety of the rider 34 and horse 15. An orthotic profile to the stirrup reduces pain and discomfort in the rider's feet.

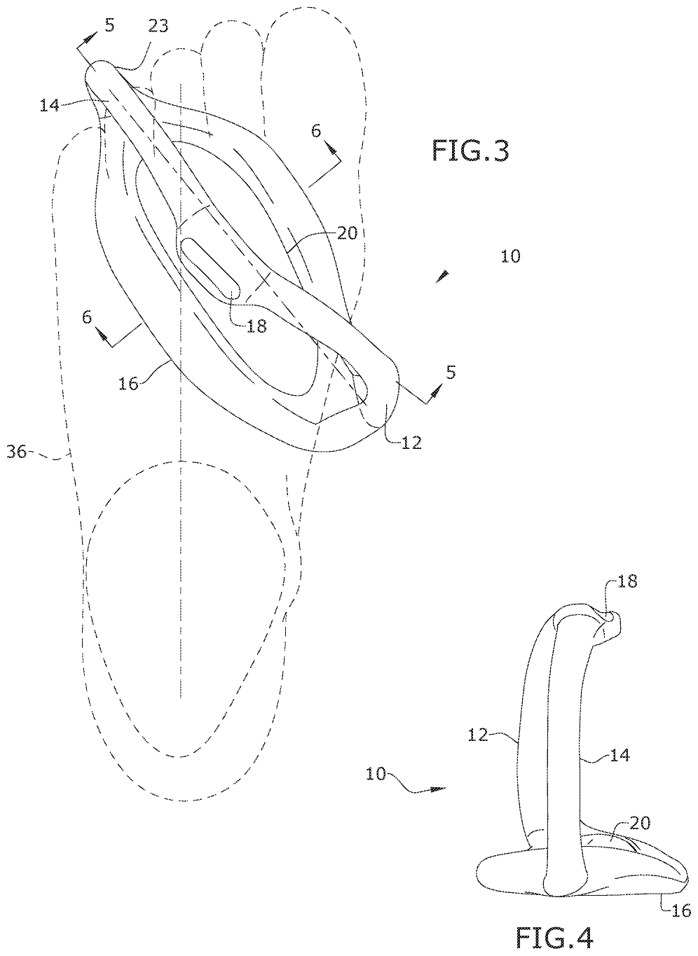

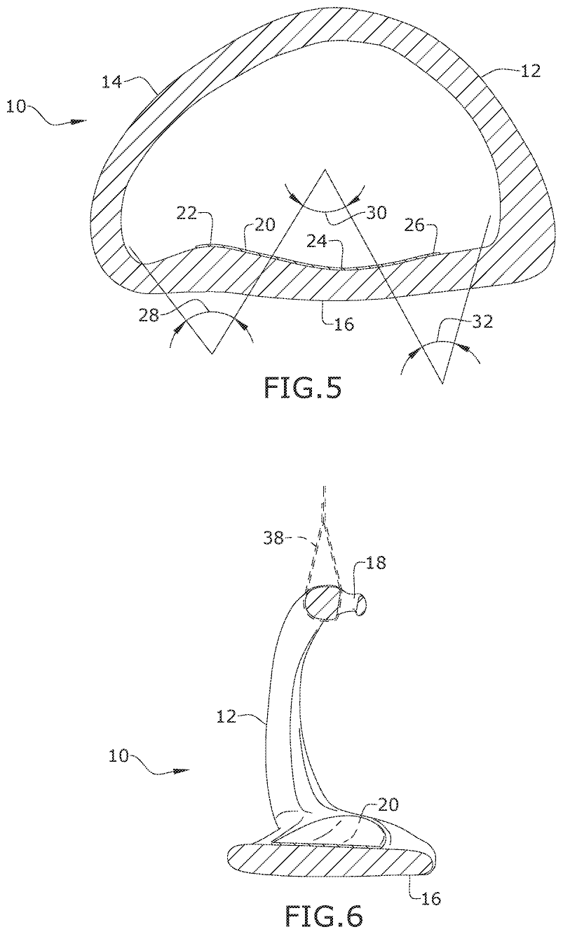

In the embodiment of the invention shown in reference to FIGS. 2-6, primarily intended for thoroughbred racing, the stirrup 10 includes an inverted U-shaped arch having a downwardly extending aft bar 12 and a forward bar 14. A baseplate 16 extends between the aft bar 12 and the forward bar 14. The stirrup 10 is secured to a saddle 35 by a suspension strap 38 carried in a strap opening 18 defined at an apex of the inverted U-shaped arch. When a protrusion is present at the strap opening 18, the protrusion would be positioned facing away from the body of the horse 15.

The strap opening 18 is substantially aligned with a longitudinal axis of the stirrup 10 along the forward bar 14 and the aft bar 12, such that, when coupled with the saddle 35, the longitudinal axis of the stirrup 10 is substantially aligned with a longitudinal length of the horse 15.

The baseplate 16 has an ovoid teardrop shape with a wide portion positioned forwardly, proximal to the forward bar 14 and converges inwardly towards the aft bar 12. An instep portion 20 of the baseplate 16 is defined by an elevated region to support a medial longitudinal arch of the rider's foot and the transverse arch of the rider's foot, when received in the stirrup 10.

A forward end of the baseplate 16 has an elevated transverse arc 22 defined between a medial aspect of the base plate 16 and a lateral aspect of the baseplate 16 and aft of the forward bar 12. The elevated transverse arc 22 angles rearwardly from the medial to the lateral aspects of the base plate 16. The transverse arc 22 is defined along the space between the heads of the metatarsals of a rider's foot and the toes of the rider's foot. The transverse arc 22 has a radius of curvature 28 of between about 50 degrees and 60 degrees, preferably about 55 degrees.

The transverse arc 22 is configured for an indexed engagement with a corresponding transverse arc 44 defined in the bottom sole of a footwear worn by the rider 34. The corresponding transverse arc 44 may be defined by a depression in the bottom sole of the footwear, a thinning or softening of the bottom sole, or a combination thereof. The transverse arc 22 and corresponding transverse arc 44 may permit the rider 34 to grip the stirrup 10 for a better control and feel at the interface with the horse 15.

A toe notch 23 is defined at the forward end of the baseplate 16 and is interposed between the elevated transverse arc 22 and the forward bar 12. A medial face of the toe notch 23 may be dimensioned to carry the first through third toes in a gripping relation at a forward end of the baseplate 16. A lateral face of the toe notch 23 is dimensioned carry the fourth and fifth toes in a griping relation with the forward end of the baseplate 16 providing the rider 34 a better feel with the stirrups 10.

The baseplate 16 has a lateral width at a mid portion 24 that is dimensioned to provide an orthotic support to the medial longitudinal arch and a lateral longitudinal arch of the rider's foot. The mid portion 24 may have depression with a radius of curvature 30 of between about 39 degrees and 49 degrees, preferably about 44 degrees. An elastomeric pad may be applied to the baseplate 16 to provide a cushion between the baseplate 16 and the rider's footwear.

As seen in reference to FIG. 6, the aft leg 12 will have a radiused surface on a lateral side of the aft leg 12 that is defined to partially support the medial longitudinal arch of the wearer's foot. The baseplate 16 may have an upward curvature approaching the aft leg 12 with a radius of curvature 32 of between about 41 degrees and 51 degrees, preferably about 46 degrees.

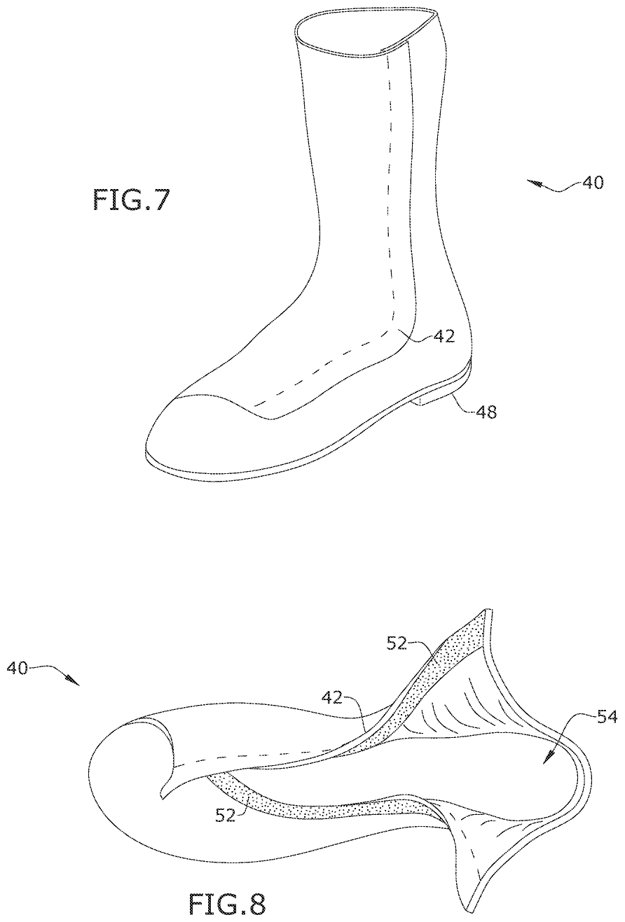

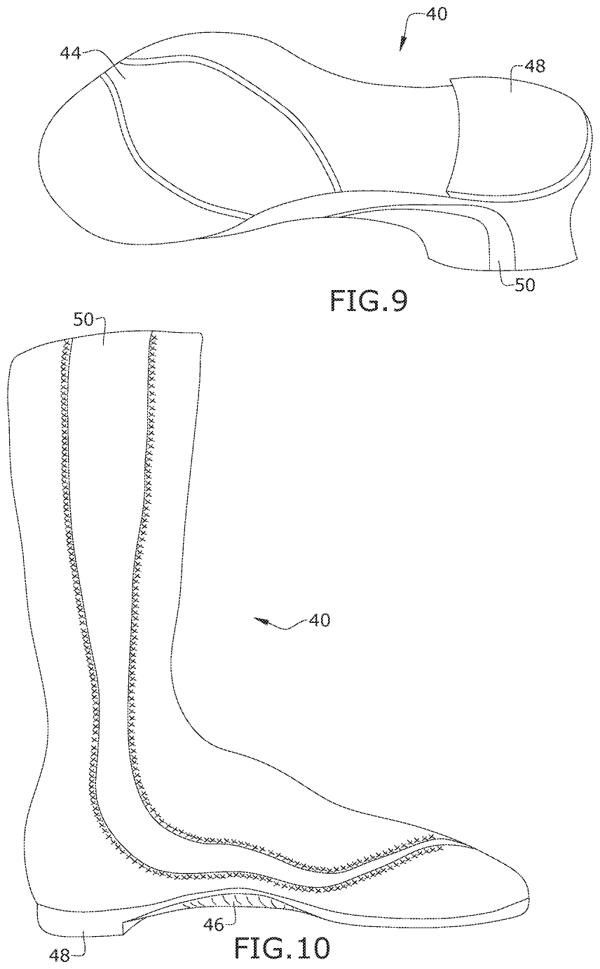

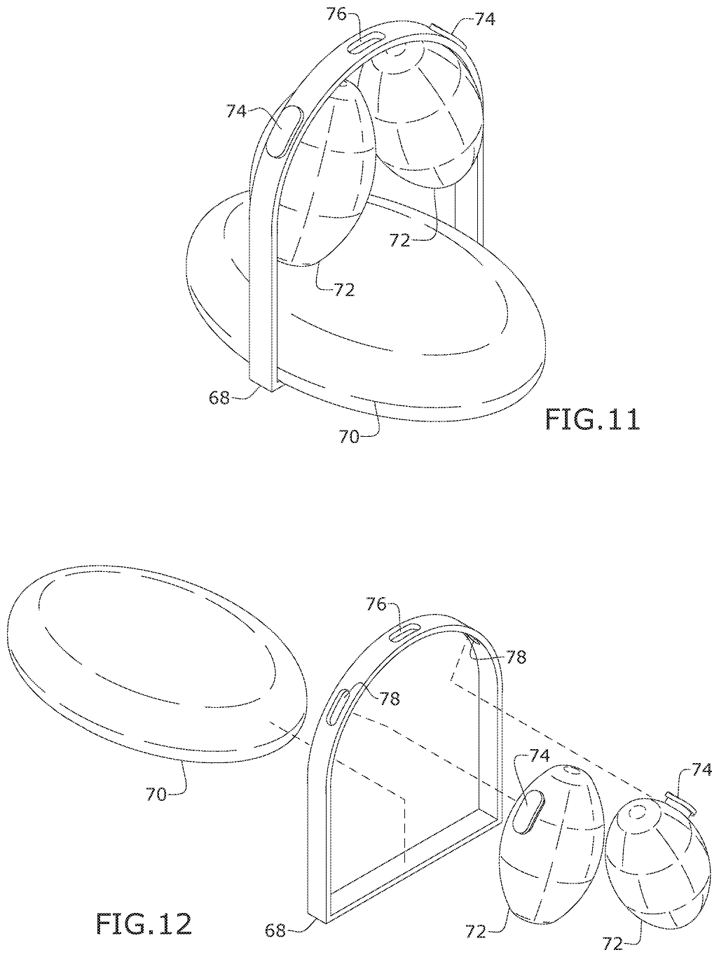

As seen in reference to FIGS. 7-11, a riding boot 40 according to aspects of the invention may include a boot structure having a flap 42 that is releasably joined about the rider's foot and shin via a cooperating fastener 52. The riding boot 40 may be utilized with but is not limited to use with the racing stirrup 10, described above, or a therapy stirrup 68, described below. The fastener 52 may be a cooperating Velcro® material or a zipper. The fastener 52 extends along a lateral side of a foot portion of the boot 40 and upwardly along the shin.

In some embodiments, a bottom sole of the riding boot 40 may include one or more pads defined according to the stirrup configuration, at the toes and at the heads of the metatarsals. As previously indicated, the corresponding transverse arc 44 is defined in the bottom sole of a footwear worn by the rider 34 between the positions of the pads. A medial arch notch 46 may also be provided on the bottom sole of the footwear 40. Likewise, a heel 48 may also be provided on the bottom sole of the footwear.

The corresponding transverse arc 44 may be defined by a depression in the bottom sole of the footwear, a thinning or softening of the bottom sole, or a combination thereof. In some embodiments, the pads may be formed as protrusions or an inlay on or within the bottom sole of the footwear. In the racing stirrup 10, the transverse arc 22 and corresponding transverse arc 44 permit the rider 34 position the footwear in and indexed relation with the stirrups 10 for a positive positioning and placement of the rider's feet with the stirrups 10. The medial arch notch 46 is dimensioned to engage with the aft leg 12 of the stirrup 10. In a therapy embodiment of the boot 40, the bottom sole may be configured to correspond and index with a curvature of an ellipsoidal bottom pad 70 of the therapy stirrup 68.

In some embodiments the boot 40 may be formed with a neoprene material 50 to provide the rider 34 with a better feel for the stirrups 10, 68. The boot 40 may also include an orthotic insert 54. The orthotic insert 54 may include a plurality of layers to cushion the rider's 34 foot against the stirrups 10, 68.

A therapy stirrup 68 is shown in reference to FIGS. 12 and 13. The therapy stirrup includes a generally inverted U-shaped frame having a base leg 71 interconnecting a pair of downwardly extending legs 69. A strap slot 76 is defined at an apex of the inverted U-shaped frame for retaining the therapy stirrup 68 with a saddle.

The therapy stirrup 68 includes an ellipsoidal bottom pad 70 is coupled with the base leg 71. The ellipsoidal bottom pad 70 is configured to be indexed with a corresponding ellipsoidal region defined on the bottom sole of the boot 40 to allow the rider to have an indexed engagement of the boot 40 with the therapy stirrup 68.

Ellipsoidal lateral pads 72, 74 are positioned on the downwardly extending legs 69. In some embodiments, an attachment aperture is defined on the downwardly extending legs 69, at roughly the 10:00 and 2:00 positions. An attachment tab is provided on an outer side of the ellipsoidal lateral pads 72, 74. The attachment tab is configured for resilient engagement with the attachment apertures. The ellipsoidal lateral pads 72, 74 are oriented downwardly and inwardly to impart a slight pressure on the rider's foot to provide for a more positive engagement with the rider's foot in the therapy stirrup 68. The slight application of a pressure on the rider's foot can facilitate a better feel for the stirrups 68, particularly for riders with disabilities and limited sensation in their feet and lower extremities or for those with cognitive disabilities as a reminder to retain their feet within the stirrups 68.

An outer surface of the ellipsoidal lateral pads 72, 74 is preferably covered with a low-friction material, such as a nylon or a spandex material, so that the rider's boot 40 may be readily released from the stirrup 68 when desired.

The therapy stirrup 68 is meant to create a snug fit that allows the rider 34 to keep their foot in place while riding, while also allowing them to remove their foot with ease when desired. The cushions 70, 72, 74 may be replaceable, while the “U” shaped bar is the constant. The side cushions 72, 74 may vary in size based on riders size of foot or preference of padding. The goal is to provide better connection between the riders stirrup 68 and the structural integrity of the riders foot, marrying the foot to the stirrup 68 with proper anatomical alignment.

The manufacturing of the therapy stirrup 68, the composition of the stirrup may be manufactured by 3D printing, metal injection molding, or 4 or 5 axis machining. The composition may include a metal or a non-metal materials such as plastics, polymers or a lightweight metal/alloy.

The ellipsoid cushion base 70 supports the transverse/longitudinal/medial arch and the inner (left and right-side ellipsoidal lateral pads 72, 74 may each be manufactured using a memory foam, a gel material, or comparable elastomeric materials.

As indicated, existing stirrups have been inefficient with the special needs of therapeutic riding, whether that be security, gaining feeling, or improper pressure dispersion on the rider's foot. Traditional flat bar/base stirrups used for or with the intention of therapeutic riding promotes an overuse of muscles, leads to leg and foot spasms, and does not properly align the foot, or provide security for the rider 34.

The hippotherapy/therapy stirrup 68 is the first type of stirrup with orthopedic benefits, providing structural alignment and promoting overall muscle integrity, specifically intended for hippotherapy/therapy horse riding. The ellipsoid platform or orthotic platform base 70 (when applied to the foot) supports the pad, transverse/longitudinal/and medial arch, which aligns the bones of the foot to improve muscle integrity and stability.

It should be understood, of course, that the foregoing relates to exemplary embodiments of the invention and that modifications may be made without departing from the spirit and scope of the invention as set forth in the following claims.

What is claimed is:

1. A riding stirrup, comprising:
an inverted U-shaped arch having a downwardly extending aft bar and a downwardly extending forward bar;
a baseplate extends between the downwardly extending aft bar and the downwardly extending forward bar, the baseplate having an ovoid teardrop shape with a wide portion positioned forwardly, proximal to the downwardly extending forward bar and converges inwardly towards the downwardly extending aft bar; and
an instep portion of the baseplate is defined by an elevated region to support a medial longitudinal arch of a rider's foot and a transverse arch of the rider's foot, when received in the riding stirrup.

2. The riding stirrup of claim 1, further comprising:
a strap opening is substantially aligned with a longitudinal axis of the riding stirrup along an arch of the downwardly extending forward bar and the downwardly extending aft bar, such that, when coupled with a saddle, the longitudinal axis of the riding stirrup is configured to be substantially aligned with a longitudinal length of a horse.

3. The riding stirrup of claim 1, further comprising:
an elevated transverse arc defined at forward end of the baseplate between a medial aspect of the baseplate and a lateral aspect of the baseplate and aft of the downwardly extending forward bar, the elevated transverse arc angles rearwardly from the medial aspect to the lateral aspects of the baseplate, the elevated transverse arc configured to align with a space between a head of a metatarsal of the rider's foot and toes of the rider's foot.

4. The riding stirrup of claim 3, wherein the elevated transverse arc is configured for an indexed engagement with a corresponding transverse arc defined in a bottom sole of a footwear worn by a rider.

5. The riding stirrup of claim 3, wherein the elevated transverse arc has a radius of curvature of between about 50 degrees and 60 degrees.

6. The riding stirrup of claim 4, wherein the elevated transverse arc has a radius of curvature of about 55 degrees.

7. The riding stirrup of claim 3, further comprising:
a toe notch defined at the forward end of the baseplate and is interposed between the elevated transverse arc and the downwardly extending forward bar.

8. The riding stirrup of claim 7, further comprising:
a medial face of the toe notch dimensioned to carry a first through a third toe of a rider in a gripping relation at a forward end of the baseplate.

9. The riding stirrup of claim 8, further comprising:
a lateral face of the toe notch dimensioned carry a fourth and a fifth toe of a rider in a griping relation with the forward end of the baseplate.

10. The riding stirrup of claim 9, wherein the baseplate has a lateral width at a mid portion that is dimensioned to provide an orthotic support to the medial longitudinal arch and a lateral longitudinal arch of the rider's foot.

11. The riding stirrup of claim 10, wherein the mid portion has a depression with a radius of curvature of between about 39 degrees and 49 degrees.

12. The riding stirrup of claim 11, wherein the depression is about 44 degrees.

13. The riding stirrup of claim 1, further comprising:
an elastomeric pad may be applied to the baseplate to provide a cushion between the baseplate and a footwear of the rider.

14. A therapy riding stirrup, comprising:
a generally inverted U-shaped frame having a base leg interconnecting a pair of downwardly extending legs;
a strap slot defined at an apex of the inverted U-shaped frame for retaining the therapy riding stirrup with a saddle; and
an ellipsoidal bottom pad coupled with the base leg, the ellipsoidal bottom pad is configured to be indexed with a corresponding ellipsoidal region defined on a bottom sole of a therapy riding boot to allow a rider to have an indexed engagement of the therapy riding boot with the therapy riding stirrup.

15. The therapy riding stirrup of claim 14, further comprising:
ellipsoidal lateral pads are coupled with the pair of downwardly extending legs.

16. The therapy riding stirrup of claim 15, further comprising:
an attachment aperture defined on the pair of downwardly extending legs, at roughly a 10:00 and a 2:00 position.

17. The therapy riding stirrup of claim 16, further comprising:
an attachment tab is provided on an outer side of the ellipsoidal lateral pads, the attachment tab configured for resilient engagement with the attachment apertures.

18. The therapy riding stirrup of claim 17, wherein the ellipsoidal lateral pads are oriented downwardly and inwardly to impart a slight pressure on a rider's foot to provide for a more positive engagement with the rider's foot in the therapy riding stirrup.

19. The therapy riding stirrup of claim 18, further comprising:
a low-friction material covering an outer surface of the ellipsoidal lateral pads.
